(19) United States
(12) Patent Application Publication
(10) Pub. No.: US 2007/0199514 A1
(43) Pub. Date: Aug. 30, 2007

(54) Electromagnetic apparatus and methods for affecting behavior in elasmobranch fish

(76) Inventors: Jeremy Cheron, Alexandria, VA (US); Soorena Sadri, Potomac, MD (US)

Correspondence Address: KENYON & KENYON LLP, 1500 K STREET N.W., SUITE 700, WASHINGTON, DC, 20005, US

(21) Appl. No.: 11/360,765

(22) Filed: Feb. 24, 2006

(51) Int. Cl. A01K 61/00

(52) U.S. Cl. 119/220

(57) ABSTRACT

The present invention provides an apparatus for selectively affecting the behavior of elasmobranch fish such as rays, skates and sharks, with electromagnetic waves. The apparatus comprises a power source, an electrical circuit capable of generating a selected voltage and current in a selected frequency, an antenna to transmit the generated electromagnetic waves, and an optional control means disposed between the power source and the antenna. In operation, this apparatus generates and transmits electromagnetic waves whose effects are perceivable by certain aquatic elasmobranch fish, which can be adjusted to cause a selected behavior, such as attraction or repulsion. The characteristics of the emitted electromagnetic waves can be controlled and changed to fit the desired needs. The apparatus can be self-contained or part of a larger system, and can be incorporated into devices such as lifejackets, buoys, life rafts, beach protection lines, communication protection lines, surf boards, kayaks, fishing lines, fishing nets, scuba gear, and an optional control means disposed between the power source and the antenna offshore oil drills and refineries.

### FIELD OF INVENTION

The present invention relates to an apparatus that can induce selected behaviors in elasmobranch fish, e.g., sharks, rays and skates, by the use of electromagnetic waves.

### BACKGROUND

Many aquatic creature-repellant devices, have been designed over the years mainly for sharks. Most such devices, recently, rely on the electro-perception of sharks that is performed by the ampullae of Lorenzini in the nose of the shark, ray or skate. These organs have been shown to be very sensitive to electrical fields, as demonstrated by Dr. Adrianus J. Kalmijn. With electric fields decreasing down to 5 nVcm−1 at distances up to 30 cm, Kalmijn was able to stimulate feeding attacks in sharks, rays and skates. It should be appreciated that this research was conducted against the background that the human body, especially when the skin is damaged, creates substantially stronger bioelectric fields which some sharks can detect from distances up to at least one meter. The galvanic fields of metallic objects are usually even stronger, which, according to Kalmijn, would explain the unusual behavior of sharks toward metallic gear underwater such as communication lines and sonar gear. Therefore, shark repulsion may be achieved by overstressing their natural electro-sensors.

U.S. Pat. No. 5,566,643 defines a method and equipment for controlling sharks, wherein electrodes are immersed in water, and applying electrical pulses thereto creates an electric field. The literature makes it clear that ampullary receptors are sensitive to electric fields rather than current flow. Yet, as science as known for quite some time, changing magnetic fields also creates electric fields.

### SUMMARY OF THE INVENTION

Alternating a current in an antenna, such as a coil of wire, produces an alternating magnetic field. This is the basis for a magnetic dipole antenna. A dipole antenna transmitting electromagnetic waves of a selected frequency can affect selectively the electro-receptors of elasmobranch fish, e.g., sharks, rays and skates, to cause a selected response. This has been experimentally proven by the inventors; a magnetic dipole antenna producing an electromagnetic wave in the proper frequency (e.g., about 10 Hz-40 Hz for repulsion) will cause the desired behavior in the elasmobranch fish. Not only does this method of an alternating current, magnetic dipole antenna provide a more efficient field and lower power consumption than the pulsed electric field, dual electrode method of the prior act, it also covers a greater distance for the same power, since the decay of the electric field is over distance squared instead of over distance cubed. Also the apparatus and methods of the present invention allow for safer construction of the device with safety in mind, and for a smaller size, since there is only one antenna and not two electrodes to work with. Furthermore, humans are more sensitive to electric fields than they are to magnetic fields; the apparatus and methods of the present invention are less likely to create a strong current that may affect the human user and non-target aquatic life, whereas users of prior art electrode devices have complained of irritation and some pain, a result of the current created by the direct electric field of the device. Finally, the prior art electrode method has size and use limitations, whereas an apparatus embodying the present invention is not limited in size or shape, since antennas can come in all shapes and sizes.

An object of the present invention is to provide an apparatus and method for controlling elasmobranch fish, such as sharks, rays, and skates, by the use of electromagnetic waves. In accordance with the present invention there is an apparatus that comprises: a power source; an electrical circuit connected to the power source, capable of converting power from the power source into a selected voltage/current in the desired frequency; an antenna connected to the electrical circuit, used to transmit the generated electromagnetic waves produced from the current and voltage received from the electrical circuit and power source, thereby producing the required electromagnetic waves in the required frequency needed to repel or attract sharks, rays and skates selectively; optional and optionally a controlling system, including a switch for turning the system on and off, disposed between the power source and the antenna.

### BRIEF DESCRIPTION OF THE FIGURES

FIG. 1 illustrates an electrical circuit that can produce the desired current, voltage and frequency from a DC power source and deliver it to a transmitting antenna.

FIG. 2 illustrates another electrical circuit that can produce the desired current, voltage and frequency from a DC power source and deliver it to a transmitting antenna.

FIG. 3 illustrates a system flowchart describing how the electromagnetic wave will be produced from an AC power source.

FIG. 4 illustrates a rod design of the apparatus to be used by divers, surfers or other types of users.

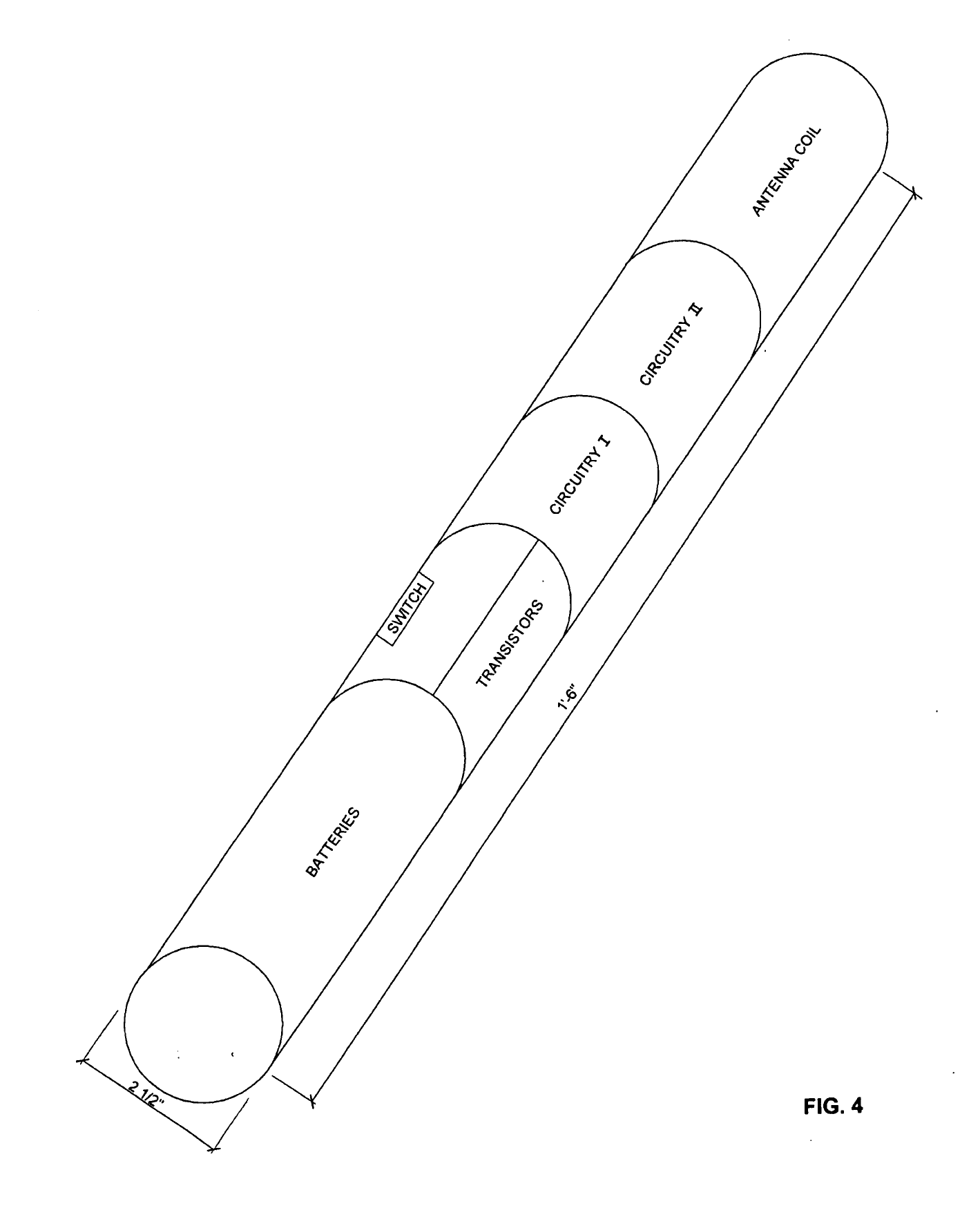

FIG. 5 illustrates another rod design of the apparatus to be used by divers, surfers and other types of users.

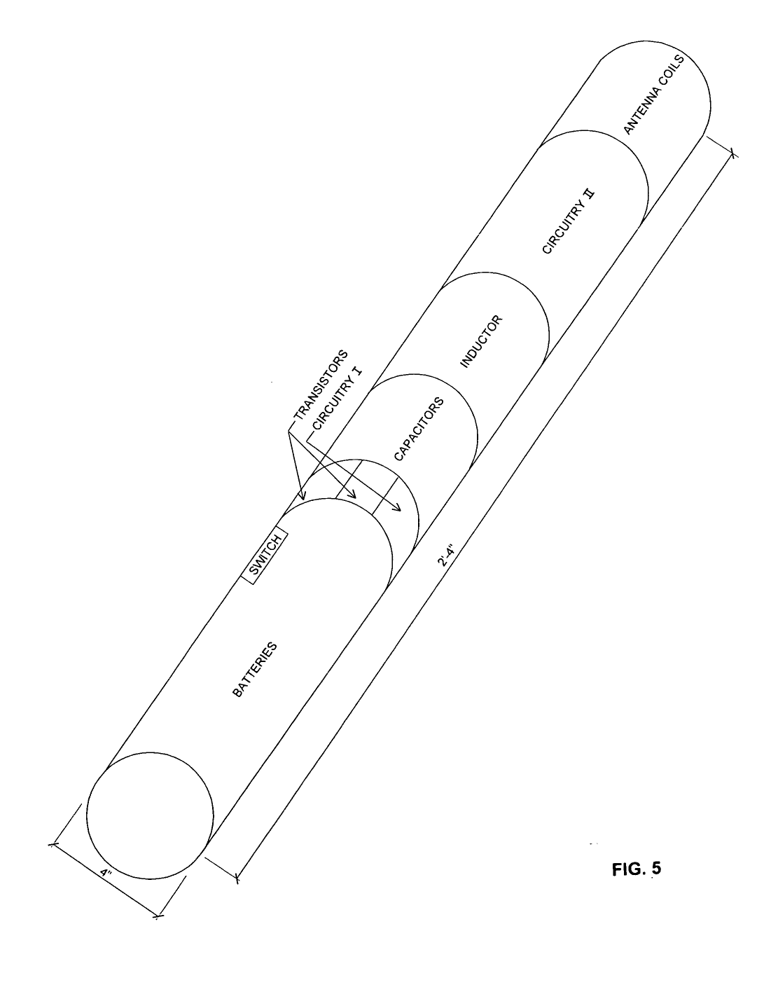

FIG. 6 illustrates a box design of the apparatus to be used in kayaks, on ships or in lifeboats, or for other uses.

FIG. 7 illustrates the apparatus being used to protect beaches.

FIG. 8 illustrates the apparatus according to one embodiment of the present invention integrated into a surfboard.

FIG. 9 illustrates the apparatus according to one embodiment of the present invention integrated into a lifejacket.

### DETAILED DESCRIPTION OF THE INVENTION

The present invention provides an apparatus and methodology for selectively controlling electromagnetic sharks, rays, and skates, by the use of generated electromagnetic waves. The apparatus comprises a power source, an electric circuit capable of converting power delivered from the source to a selected voltage, current and frequency, a transmitting antenna and an optional control system disposed between the power source and the antenna. In operation, this apparatus can generate and transmit electromagnetic waves that are perceivable by elasmobranch fish, providing an ability to control their behavior selectively, for example attracting them or repelling them. The power source provides the necessary voltage and current to allow the apparatus to operate. The optional control system is interconnected to the apparatus to allow for the controlled operation of the system, and preferably contains a switch to allow the user to turn the system on or off. In addition to this the control system optionally can be connected one or more sensors placed over the system, preferably comprising a microprocessor, allowing for greater safety and power consumption monitoring and precision, for example by calculating and controlling power use for efficiency measuring and implementing safety constraints, maintaining frequency within a selected range, controlling power or controlling current supplied to the antenna. The electric circuit is connected to the power source and will convert the delivered power in the selected voltage, current and frequency. The voltage and current is variable depending on the range and kind of affect desired by the user, preferably to the 0.1 Hz to 40 Hz range for repulsion of sharks, rays and skates. In an embodiment wherein the power source is direct current (DC), such as a battery, the circuit is such that the direct current is converted to an alternating current (AC) in a selected frequency; if the power source is AC, e.g., from a city power grid or boat generator, the circuit is such that the frequency of the AC, usually 50 Hz to 60 Hz, is converted to a selected frequency, preferably about 0.1 to 40 Hz. Finally, the transmitting antenna is connected to the electric circuit in a manner to receive the voltage, current and frequency delivered from the power source and electric circuit, generate the electromagnetic wave, and transmit it through the water. The electromagnetic waves generated by the apparatus of the present invention also will not kill affected elasmobranch fish, or other aquatic life, like the current electric field nets do. The apparatus according to the present invention can be self-contained or part of a larger system.

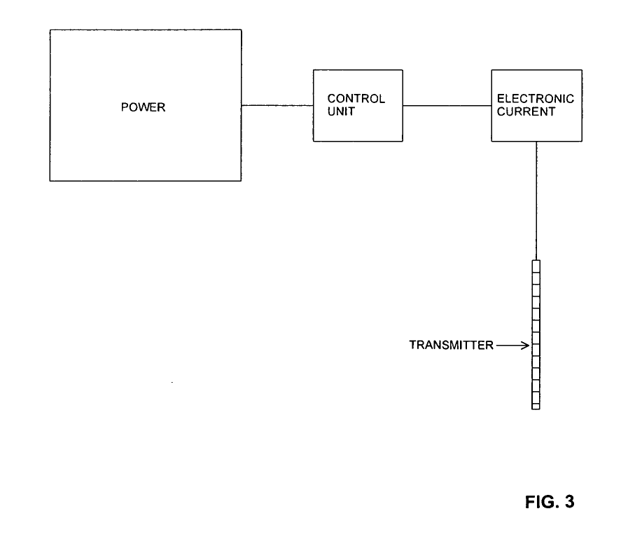

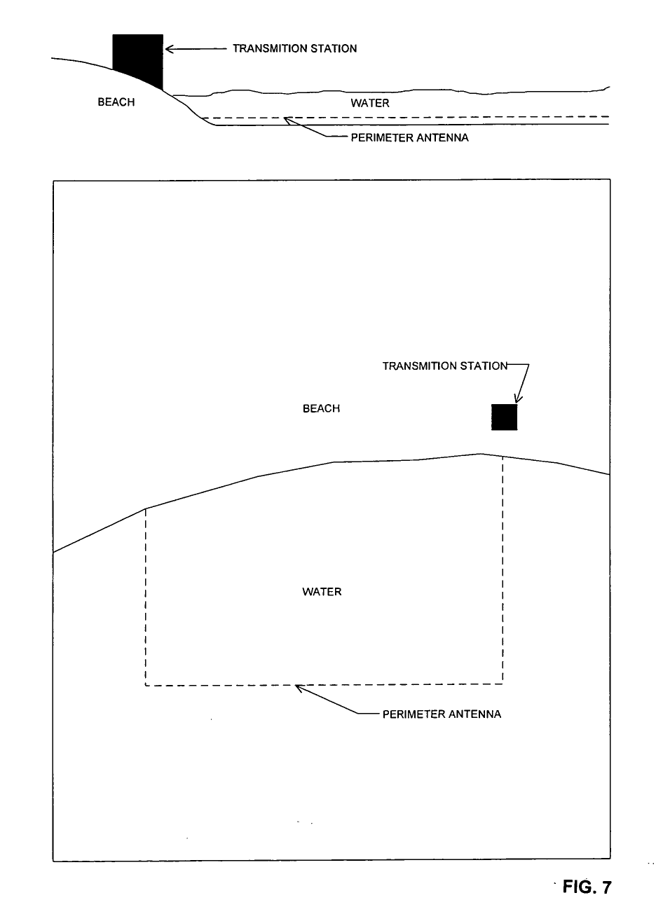

In one embodiment of the invention the power supply is an external source, such as a city electrical grid (FIG. 3). In this embodiment, the power source passes through a main switch and the control system, and into the electric circuit where the power is drawn and the 50/60 Hz frequency is converted to a selected range, preferably about 0.1 to 40 Hz. From here the resultant AC power is delivered to an antenna, such as is a long wire coil or equally efficient antenna design running submerged in the water along the water perimeter of fixed area (FIG. 7). The created and transmitted electromagnetic wave travels through the water creating a zone where elasmobranch fish will not enter or to which they can be attracted. When operating to create a “safe zone” from which affected elasmobranch fish are excluded, this antenna preferably is placed deep enough and far enough away to not cause any concern to humans or water craft, but shallow enough to allow for enough of the transmitted wave to travel into the air beyond the surface far enough to keep affected elasmobranch fish from “jumping” over the field and entering the safe zone (a fatal flaw in the bubble nets of the prior art). Examples of fixed areas where such an embodiment may be deployed include breaches, piers and off-shore platforms (such as oil or natural gas drilling platforms, refining platforms or tanker loading/unloading platforms). A similar embodiment has the antenna running around, near or alongside an underwater communication cable to keep sharks, rays and skates from biting and damaging it.

In another embodiment of the invention the power supply is an external source, such as a portable generator. A ship or boat can connect the main switch, optional control system, electric circuit and antenna to the boat or ship's onboard generator, which will then supply the power. From there the supplied power is passed through the electric circuit, converting the power into a selected frequency that will then be sent to the antenna. The antenna also can be small wire coils or sections embedded into a fishing line that, which, when the system is on, will transmit the desired electromagnetic field and keep sharks and other elasmobranch fish away from the fishing line. The same can be applied to fishnets, crab/lobster traps and other oceanic needs such as towed sensing equipment. This will, for example, keep sharks, rays and/or skates from damaging fishing equipment or getting killed by becoming entangled in nets and traps. A similar embodiment has the generator on a submarine and the antenna near or around a towed sonar array to keep, for example, sharks, rays and/or skates from biting and damaging the array.

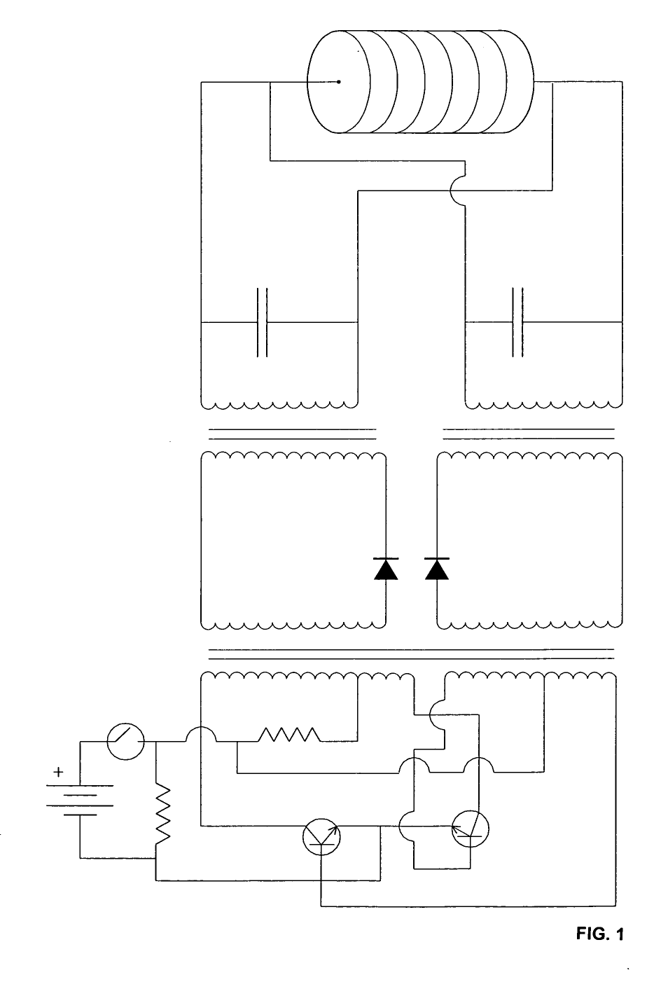

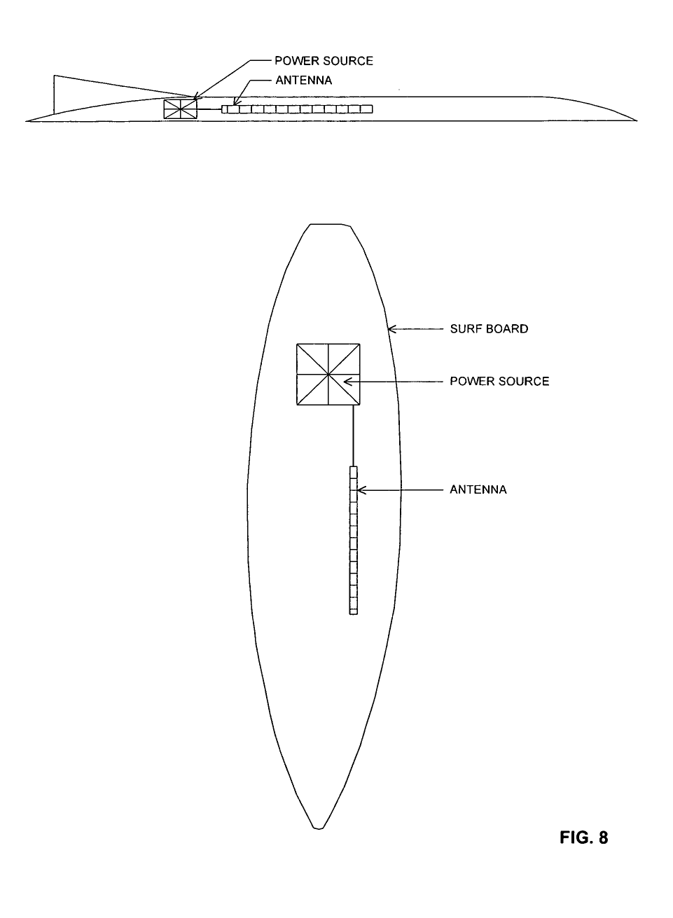

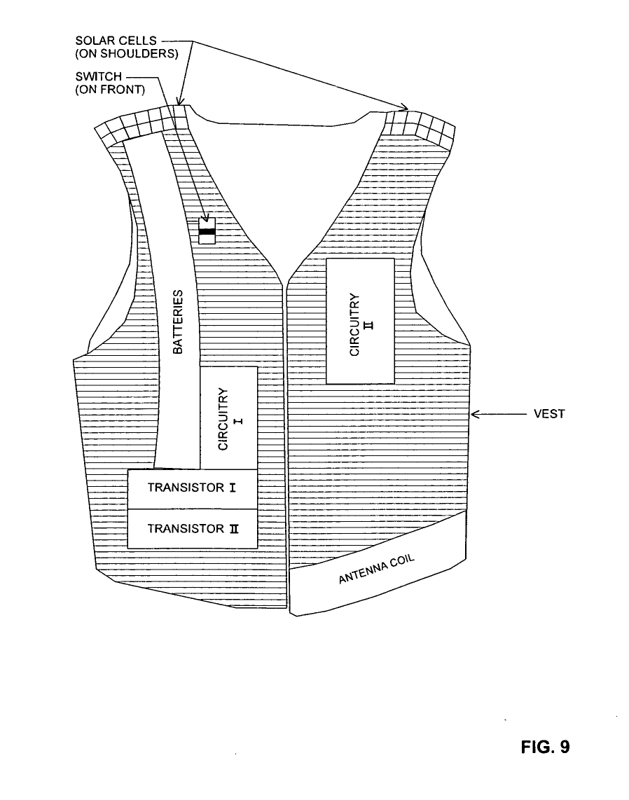

In another embodiment of the invention the power source is a DC supply (FIG. 1), such as a battery, and is connected to the control system, power switch, electric circuit and antenna. The electric circuit takes the DC power and converts it to AC with a selected voltage, current and frequency (for example, in the 0.1 Hz-40 Hz range) and sends it to the antenna. The control system monitors the system for power consumption and safety, and can also give an indication when the battery is low, but can be taken out if a smaller unit is required. This system embodiment is preferably self-contained, with solid state circuitry, and can be embedded into, for example, life jackets (FIG. 9) or a surfboard (FIG. 8), or can be carried and used for surfing, swimming, scuba diving or any other basic water activity with the purpose of keeping elasmobranch fish, such as sharks, rays, and/or skates, away from the user.

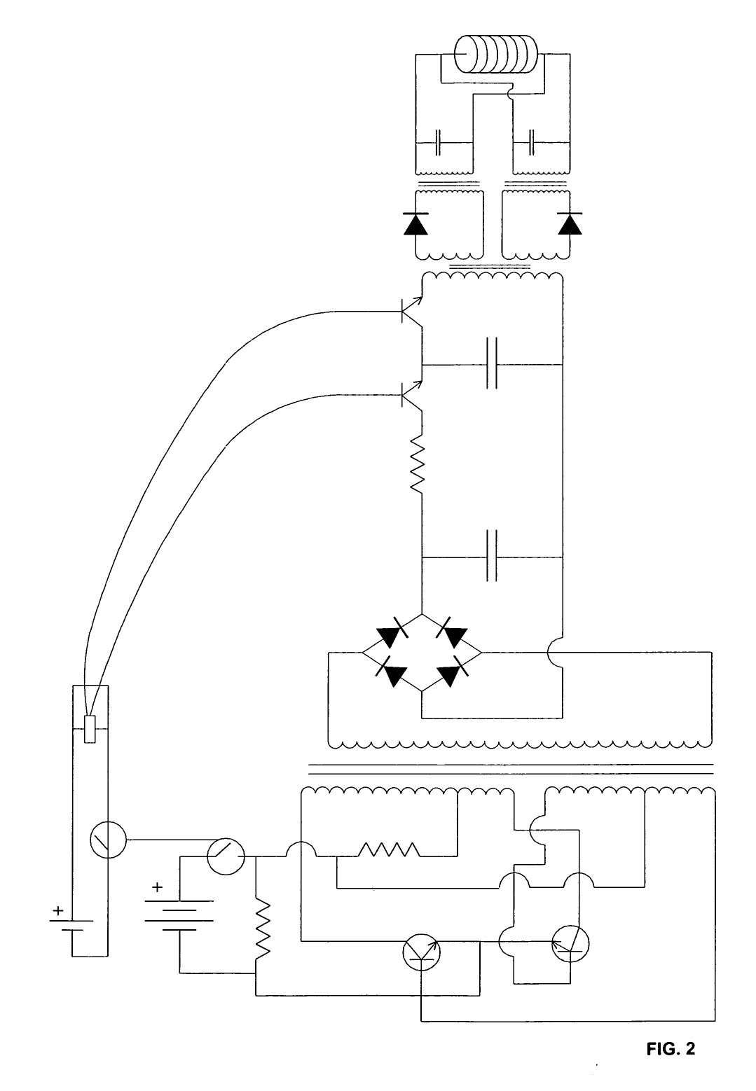

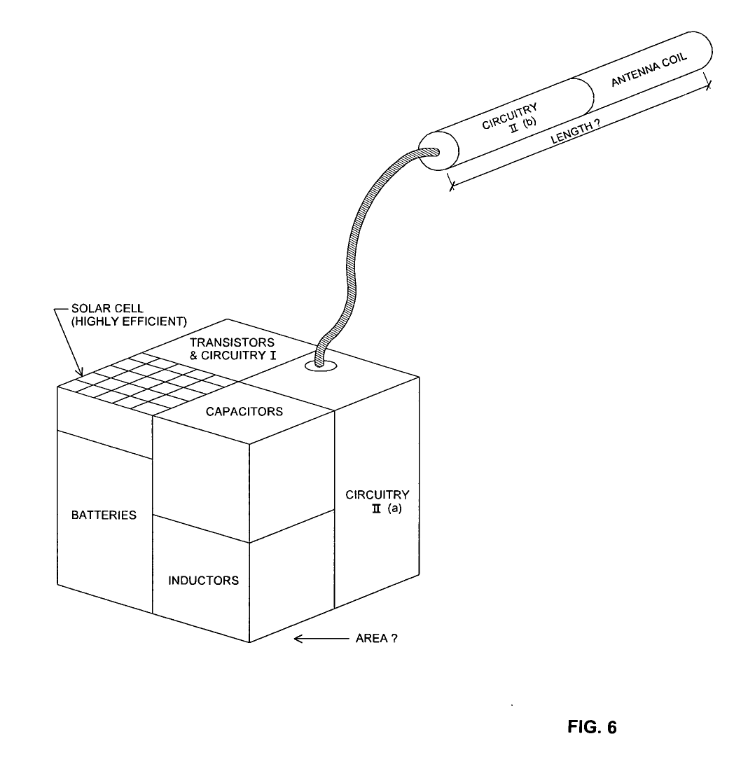

In another embodiment of the invention wherein the power source is a DC supply (FIG. 2), such as a battery, and is connected to a control system, power switch, electric circuit and antenna; it can be self-contained or set up in parts. The electric circuit for this embodiment takes the power delivered by the power supply and charges a LC tank circuit, which converts the delivered power to a selected frequency (e.g., in the 0.1 Hz-40 Hz range) and sends it to the antenna. This method of power conversion reduces the total draw from the power supply and can extend the lifetime of the power supply. A second smaller power supply (e.g., one or more batteries) can optionally be employed to run the timing and switching components. This embodiment can be embedded in a water craft, for example a kayak, life raft, or life boat, for protection from sharks. It can also be made separate and placed in a water craft or otherwise carried by an individual (FIG. 6), for protection from sharks. Sharks have been known to attack kayaks and life rafts, and if a person is hanging off the side they are open to attack. This embodiment of the invention can provide protection for the life raft and for any people in the water hanging on to it.

As would be known to a worker skilled in the art, the apparatus of the present invention can be integrated into a number of different devices. In addition, the integration of the apparatus may be performed during or after the fabrication of a particular device. A worker skilled in the art would also understand how to position each of the elements of the apparatus in order to provide for example, protection for the components, or convenience for the user during operation. Selection of an affective frequency range can be made based on knowledge within the art, or achieved by means of simple experimentation within the ordinary skill in the art. For example, it is known in the art that elasmobranch fish, such as sharks, are repelled by electromagnetic frequencies in the 0.1 to 40 Hz range. It is within the skill in the art to test and select frequencies within this range for an optimal repellant effect, as well as to test and select frequencies in other lower power ranges to induce other behaviors in elasmobranch fish, such as attraction or feeding. The attraction or feeding of elasmobranches fish can be controlled in a section of the same frequencies (0.1 to 5 Hz) operating at a much lower power than used for repulsion.

### REFERENCES CITED

U.S. Patent Documents

U.S. Pat. No. 4,211,980 A July 1980 Stowell
U.S. Pat. No. 4,359,836 A November 1982 Yuji
U.S. Pat. No. 4,593,648 A June 1986 Marzluf
U.S. Pat. No. 4,667,431 A May 1987 Mendicino
U.S. Pat. No. 4,750,451 A June 1988 Smith
U.S. Pat. No. 4,825,810 A May 1989 Sharber
U.S. Pat. No. 5,214,873 A June 1993 Sharber
U.S. Pat. No. 5,327,854 A July 1994 Smith et al.
U.S. Pat. No. 5,341,764 A August 1994 Sharber
U.S. Pat. No. 5,566,643 A October 1996 Charter et al.
U.S. Pat. No. 6,837,182 B2 January 2005 Leblanc
   Other Publications
Neiman, A. B. et al. “Stochastic synchronization of electroreceptors in the paddlefish” The Shark Natal Board Shark-POD Diver Unit.
Jin Lu and M. Fishman, 1995. Ion Channels and Transporters in the Electroreceptive Ampullary Epithelium from Skates. Biophysical Journal; Vol. 69.
R. C. Peters and H. P. Evers, 1985. Frequency Selectivity in the Ampullary System of an Elasmobranch Fish. Laboratory of Comparative Physiology.
J. C. Montgomery, 1984. Noise cancellation in the electrosensory system of the thomback ray; common mode rejection of the input produced by the animals' own ventilatory movement. F. comp. Physiol. 155A, 103-111.
R. W. Murray, 1965. Electroreceptor mechanisms: the relation of impulse frequency to stimulus strength and responses to pulsed stimuli in the ampulla of Lorenzini of elasmobranches. J. Physiol. (Lond.) 180:592-606.

1. In apparatus for inducing behavior in elasmobranch fish, said apparatus comprising:
a) power supply;
b) an electrical circuit capable of receiving power from the power supply and converting the power into a selected voltage, current and alternating frequency;
c) an antenna capable of receiving the converted power from the electrical circuit and transmitting the converted power as an alternating electromagnetic field,
wherein the selected voltage, current and frequency induce a selected behavior in elasmobranch fish.

2. An apparatus according to claim 1, wherein the selected behavior is repulsion.

3. An apparatus according to claim 1, further comprising at least one control means, disposed between the power source and the antenna, capable of controlling the flow of power between the power source and the antenna.

4. An apparatus according to claim 3, further comprising a sensing means capable of detecting selected thresholds of power flow within the apparatus and providing a signal to the control means to interrupt the flow of power within the apparatus if said thresholds are reached.

5. An apparatus according to claim 1, wherein the elasmobranch fish is selected from the group consisting of: sharks, rays and skates.

6. An apparatus according to claim 5, wherein the selected frequency is between about 0.1 Hz and about 40 Hz.

7. An apparatus according to claim 1, wherein the apparatus is installed in or on a water craft.

8. An apparatus according to claim 7, wherein the water craft is selected from the group consisting of: a surf board, a life raft, a kayak, a submarine, a ship, and a boat.

9. An apparatus according to claim 8, wherein the water craft is a surf board.

10. An apparatus according to claim 8, wherein the water craft is a life raft.

11. An apparatus according to claim 8, wherein the water craft is a kayak.

12. An apparatus according to claim 8, wherein the water craft is a submarine.

13. An apparatus according to claim 1, wherein at least the antenna is installed in or on to a buoy.

14. An apparatus according to claim 1, wherein at least the antenna is installed in or on sonar array.

15. An apparatus according to claim 14, wherein the sonar array is a towed sonar array.

16. An apparatus according to claim 1, wherein the apparatus is deployed in a manner to create a zone of repulsion around a fixed area.

17. An apparatus according to claim 1, wherein at least the antenna is installed in or on aquatic life capturing means selected from the group consisting of a fishing line, a fish net, a lobster trap, and a crab trap.

18. An apparatus according to claim 1, wherein the apparatus is installed in a fixed area in a manner to create an area of protection for swimmers and/or water craft within the fixed area.

19. An apparatus according to claim 1, wherein at least the antenna is installed in or on an underwater communication line.

20. An apparatus according to claim 1, where in the apparatus is installed in or on scuba gear.

21. Use of an apparatus according to claim 1 for the control an elasmobranch fish selected from the group consisting of sharks, rays, and skates.

22. A method for inducing selected behavior in elasmobranch fish, comprising placing an apparatus according to claim 1 in operational contact with a body of water, and activating said apparatus.
